(19) United States
(12) Patent Application Publication
(10) Pub. No.: US 2017/0162097 A1
(43) Pub. Date: Jun. 8, 2017

(54) DISPLAY DEVICE AND COLOR ADJUSTING METHOD THEREOF

(71) Applicant: InnoLux Corporation, Jhu-Nan (TW)

(72) Inventor: I-Kai PAN, Jhu-Nan (TW)

(21) Appl. No.: 15/361,815

(22) Filed: Nov. 28, 2016

(30) Foreign Application Priority Data
Dec. 2, 2015 (CN) 201510869380.7

(51) Int. Cl. G09G 3/20; G09G 3/36

(52) U.S. Cl. CPC G09G 3/2003; G09G 3/3648; G09G 2320/0666

(57) ABSTRACT

A display device includes a display panel, a system circuit board and a backlight module. The system circuit board is electrically connected to the display panel and includes a storage unit. The backlight module is disposed corresponding to the display panel and emits a light to pass through the display panel. The backlight module has a light emitting unit, and the light emitting unit has an identical code. A color adjusting method of the display device includes the following steps of: identifying the identical code of the light emitting unit; obtaining a set of chromaticity coordinate values corresponding to the identical code; and storing the set of chromaticity coordinate values in the storage unit. Accordingly, the display device can achieve the goal of a better color presentation with lower cost.

### CROSS REFERENCE TO RELATED APPLICATIONS

This Non-provisional application claims priority under 35 U.S.C. §119(a) on Patent Application No(s). 201510869380.7 filed in People's Republic of China on Dec. 2, 2015, the entire contents of which are hereby incorporated by reference.

### BACKGROUND

Technical Field

The present disclosure relates to a display device and a color adjusting method thereof, and in particular, to a liquid crystal display (LCD) device and a color adjusting method thereof.

Related Art

As the progress of technologies, the flat display device has been widely applied to various fields. In particular, the liquid crystal display (LCD) device has the advantages of light weight, thin, low power consumption, and no radiation, so it gradually replaces the traditional CRT display device. The LCD device can be applied to many electronic devices such as mobile phone, portable multimedia device, laptop computer, LCD TV and LCD monitor.

The LCD device mainly includes a LCD panel and a backlight module. The LCD panel includes a color filter (CF) substrate, a thin-film-transistor (TFT) substrate, and a liquid crystal layer disposed between the substrates. The CF substrate, the TFT substrate and the liquid crystal layer form a plurality of pixels arranged in an array. The light emitted from the backlight module passes through the LCD panel, and forms an image after passing through the subpixels of the LCD panel.

In the design of a display device, the color quality is a very important factor. The color quality can be presented by the chromaticity coordinate. For example, the light emitted from a display panel can be referred to a CIE 1931 chromaticity coordinate, wherein the three primary colors (blue, green and red) have corresponding color points, which are the three end points of the chromaticity triangle. Currently, the most popular chromaticity spec is sRGB, which defines a blue primary at a point (0.150, 0.060), a green primary at a point (0.300, 0.600), and a red point (0.640, 0.330) in the CIE 1931 chromaticity coordinate. If the points of three primary colors offset from the points of the standard sRGB too much, it indicates that the image color of the display panel is distorted, which will lead to the poor image display and thus lower the image quality.

In the conventional manufacturing processes of the display device, the display panel will be given with one preset chromaticity coordinate values in each batch. In practice, the preset chromaticity coordinate values are written into the memories of the batch of display panels, and the system will perform the color adjustment of the batch of display panels according to the preset chromaticity coordinate values stored in the memories. However, this approach forbids the color calibration by the system. Otherwise, even if the color calibration by the system is possible, the real color of the display device still has a very different from the calibrated result, which will cause the color distortion of the displayed image.

If the display panels are all measured and then the measured chromaticity coordinate values are individually written into the EDID (Extended Display Identification Data) memories of these display panels, the system can calibrate the display panels according to the measured chromaticity coordinate values stored in the EDID memories, respectively, so as to obtain a more precisely color presentation. However, this method needs to perform chromaticity measurement to every display panel, which will consume a lot of time and manpower, thereby sufficiently increasing the manufacturing cost.

Therefore, it is an important subject to provide a display panel and a color adjusting method thereof that can achieve a better color presentation with lower cost so as to improve the product competitiveness.

### SUMMARY

In view of the foregoing subject, an objective of the present disclosure is to provide a display panel and a color adjusting method thereof that can achieve a better color presentation with lower cost so as to improve the product competitiveness.

To achieve the above objective, the present disclosure discloses a display panel including a display panel, a system circuit board and a backlight module. The system circuit board is electrically connected to the display panel and includes a storage unit, which stores a set of corresponding chromaticity coordinate values of the display panel. The backlight module is disposed corresponding to the display panel for emitting a light to pass through the display panel. The backlight module has a light emitting unit, and the light emitting unit has an identical code. The identical code corresponds to the set of chromaticity coordinate values.

To achieve the above objective, the present disclosure also discloses a color adjusting method of a display device. The display device includes a display panel, a system circuit board and a backlight module. The system circuit board is electrically connected to the display panel and includes a storage unit. The backlight module is disposed corresponding to the display panel for emitting a light to pass through the display panel. The backlight module has a light emitting unit, and the light emitting unit has an identical code. The color adjusting method includes the following steps of: identifying the identical code of the light emitting unit; obtaining a set of chromaticity coordinate values corresponding to the identical code; and storing the set of chromaticity coordinate values in the storage unit.

In one embodiment, the system circuit board further comprises a timing control circuit, and the storage unit is an internal memory of the timing control circuit.

In one embodiment, the system circuit board further comprises a central processing unit, and the storage unit is an internal memory of the central processing unit.

In one embodiment, the light emitting unit comprises at least a light-emitting diode, and the identical code is a color rank code, a product number, a batch number, or a manufacturing number.

In one embodiment, the system circuit board adjusts a color presentation of the display panel according to the set of chromaticity coordinate values.

In one embodiment, the set of chromaticity coordinate values indicates a point in a chromaticity coordinate corresponding to the display panel.

In one embodiment, the step of obtaining the set of chromaticity coordinate values corresponding to the identical code is to obtain the set of chromaticity coordinate values from a lookup table according to the identical code.

In one embodiment, the color adjusting method further includes a step of: adjusting a color presentation of the display panel according to the set of chromaticity coordinate values.

As mentioned above, the present disclosure is to identify the identical code of the light emitting unit, to obtain a set of chromaticity coordinate values corresponding to the identical code, and then to store the set of chromaticity coordinate values in the storage unit of the system circuit board. Accordingly, the system circuit board can adjust the color presentation of the display panel according to the set of chromaticity coordinate values. Compared with the conventional art, which is to write the preset chromaticity coordinate values into the EDID memory of the display device, the present disclosure can achieve better color presentation. In addition, compared with the conventional art of measuring the real chromaticity of all display panels, the present disclosure has the obvious advantage of lower cost, which can improve the product competitiveness.

### BRIEF DESCRIPTION OF THE DRAWINGS

The embodiments will become more fully understood from the detailed description and accompanying drawings, which are given for illustration only, and thus are not limitative of the present disclosure, and wherein:

FIG. 1A is a schematic diagram of a display device according an embodiment of the disclosure;

FIG. 1B is a perspective view of the display panel according to the embodiment of the disclosure;

FIG. 1C is a functional block diagram of the display device of FIG. 1A;

FIG. 2A is a flow chart of a color adjusting method of a display device according to an embodiment of the disclosure;

FIG. 2B is a flow chart of another color adjusting method of a display device according to the embodiment of the disclosure;

FIG. 3 is a schematic diagram showing a CIE 1931 chromaticity coordinate corresponding to the light emitted from the display device; and

FIG. 4 is a schematic diagram showing a table containing the chromaticity coordinate values in the CIE 1931 chromaticity coordinate corresponding to different identical codes.

### DETAILED DESCRIPTION OF THE DISCLOSURE

The embodiments of the disclosure will be apparent from the following detailed description, which proceeds with reference to the accompanying drawings, wherein the same references relate to the same elements.

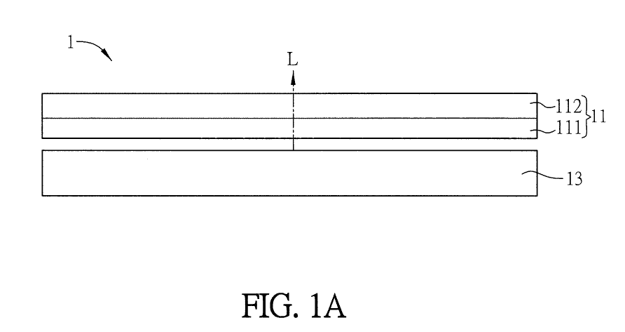

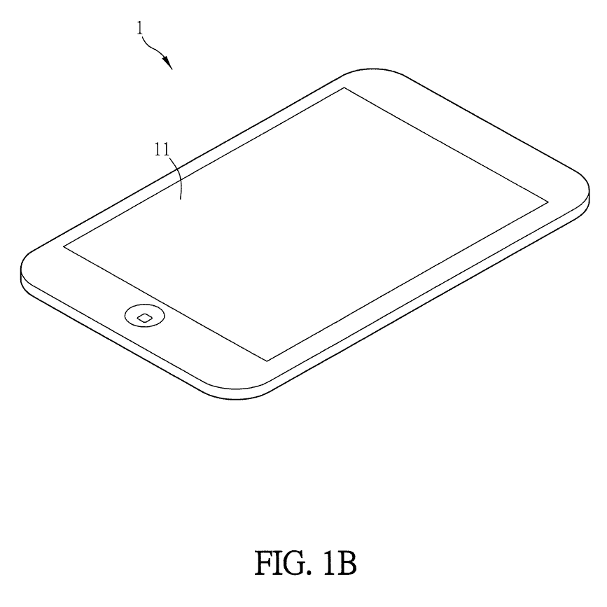

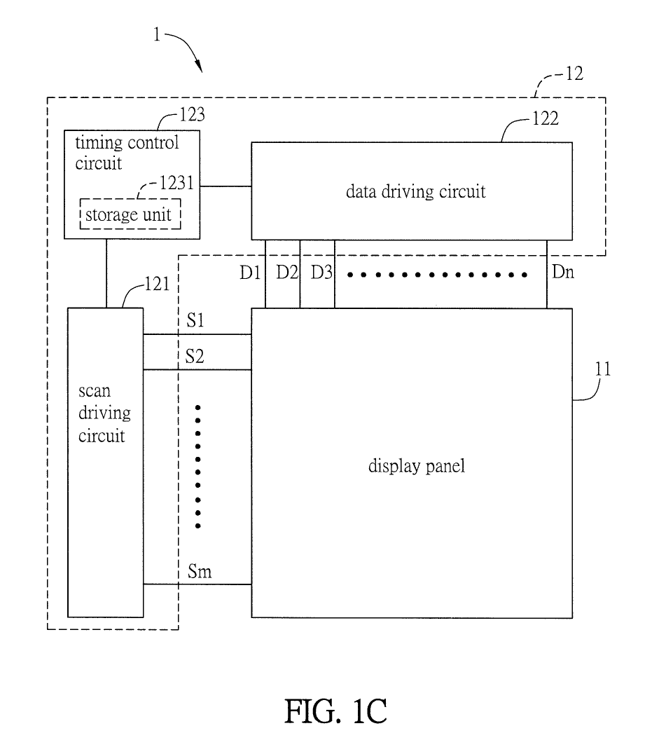

FIG. 1A is a schematic diagram of a display device 1 according an embodiment of the disclosure, FIG. 1B is a perspective view of the display panel 1 according to the embodiment of the disclosure, and FIG. 1C is a functional block diagram of the display device 1 of FIG. 1A.

The display device 1 of this embodiment is a liquid crystal display (LCD) device such as an IPS (In-plane switch) LCD device, an FFS (Fringe Field Switching) LCD device, a TN (Twisted Nematic) LCD device, or a VA mode (Vertical Alignment mode) LCD device, and this disclosure is not limited.

As shown in FIGS. 1A to 1C, the display device 1 includes a display panel 11, a system circuit board 12 and a backlight module 13, wherein the system circuit board 12 is not shown in FIG. 1A, and the backlight module 13 is not shown in FIG. 1C. The system circuit board 12 is electrically connected to the display panel 11 for controlling the operation of the display panel 11. The backlight module 13 is disposed corresponding to the display panel 11. In this embodiment, the backlight module 13 is located at one side of the display panel 11 away from a second substrate 112. The backlight module 13 emits light L, which can pass through a plurality of subpixels of the display panel 11 so as to form an image.

The display panel 11 includes a first substrate 111, a second substrate 112 and a liquid crystal layer (not shown). The first substrate 111 is, for example a TFT (thin-film transistor) substrate, and the second substrate 112 is a CF (color filter) substrate. The liquid crystal layer is sandwiched between the first substrate 111 and the second substrate 112 so as to form the subpixels. The first substrate 111 and the second substrate 112 can be made of a glass substrate, a transparent acrylic substrate, a flexible substrate or a touch control substrate, and this disclosure is not limited.

The backlight module 13 includes a light emitting unit, a light guiding plate, a reflective plate and a plurality of optical plates (not shown). The light emitting unit can be, for example but not limited to, a light-emitting diode (e.g. a LED light bar). The light emitting unit is disposed at a side of the light guiding plate, and the light emitted from the light emitting unit enters the light guiding plate. The light guiding plate can guide the transmission direction of the light. In more detailed, the light entering the light guiding plate can travel through the light guiding plate by the total reflection of the light guiding plate, and then exit the light guiding plate through the light output surface of light guiding plate. Then, the light passes through the optical plates to form a uniform surface light source. The reflective plate is disposed at the bottom of the light guiding plate for reflecting the light back the light guiding plate, thereby increasing the light utility rate. The configuration and function of the backlight module 13 are well understood by the skilled person in the art, so the detailed description thereof will be omitted.

Referring to FIG. 1C, the display device 1 further includes a plurality of scan lines S1˜Sm and a plurality of data lines D1˜Dn, which are crossly disposed to define the subpixels. In addition, the system circuit board 12 of this embodiment at least further includes a scan driving circuit 121, a data driving circuit 122 and a timing control circuit 123. The scan driving circuit 121 is coupled to the display panel through the scan lines S1˜Sm, and the data driving circuit 122 is coupled to the display panel through the data lines D1˜Dn. The data driving circuit 122 outputs a plurality of data signals corresponding to the data lines D1˜Dn for driving the corresponding subpixels. The timing control circuit 123 transmits the vertical sync signal and horizontal sync signal to the scan driving circuit 121, and converts the video signals, which are received from the external connector, into the data signal for the data driving circuit 122. The timing control circuit 123 further transmits the data signal and the horizontal sync signal to the data driving circuit 122. In addition, the scan driving circuit 121 can turn on the scan lines S1˜Sm in sequence according to the vertical sync signal. When the scan lines S1˜Sm are turned on in sequence, the data driving circuit 122 transmits the pixel voltage signals to the pixel electrodes of the subpixels through the data lines D1˜Dn according to the data signals corresponding to the rows of subpixels within a frame time, thereby allowing the display device 1 to display an image.

The system circuit board 12 further includes a storage unit 1231, which at least stores a set of chromaticity coordinate values in the CIE 1931 chromaticity coordinate corresponding to the display panel 11. In other words, the storage unit 1231 stores a set of white, red, green and blue chromaticity coordinate values (WRGB, totally 8 coordinate values). After obtaining the set of chromaticity coordinate values, the system circuit board 12 can adjust the color presentation of the display panel 11 according to the set of chromaticity coordinate values. For example, the set of white, red, green and blue chromaticity coordinate values stored in the storage unit 1231 corresponds to the following coordinates of (0.281,0.391), (0.677,0.312), (0.268,0.679), and (0.153,0.050).

In this embodiment, the storage unit 1231 is an internal memory of the timing control circuit 123. The storage unit 1231 can be a non-transitory computer readable storage medium such as ROM (including PROM, EPROM, or EEPROM), RAM, flash memory, FPGA (Field-Programmable Gate Array) memory, or any other kind of memory. Of course, in another embodiment, the storage unit can also be an internal memory of a CPU (central processing unit) of the system circuit board 12, or any other memory of the system circuit board 12 capable of storing the set of chromaticity coordinate values, and this disclosure is not limited.

The light emitting unit of the backlight module 13 has an identical code, which corresponds to the set of chromaticity coordinate values stored in the storage unit 1231. In other words, one identical code corresponds to one set of chromaticity coordinate values. In this case, the storage unit 1231 can store the EDID of the display device 1. EDID indicates the data of the screen resolution of the display panel 11 (e.g. the WRGB chromaticity coordinate values, y values, and etc.) and includes the information of manufacturer and product number. Accordingly, the storage unit 1231 can be also called the EDID memory. The system circuit board 12 can automatically adjust the resolution of the display panel 11 according to the data stored in the EDID memory (storage unit 1231). If the set of chromaticity coordinate values stored in the storage unit 1231 is closer to the real color of the display panel 11, the color presentation of the display panel 11 adjusted by the system circuit board 12 will be more precise.

In this embodiment, the light emitting unit includes at least one light-emitting diode, and the identical code can be the color rank code, product number, batch number, or manufacturing number of the light-emitting diode. In more detailed, the light-emitting diodes of the same batch have the same chromaticity coordinate range, and the light-emitting diodes of different batches have different chromaticity coordinate ranges. The chromaticity coordinate range can be obtained in the information of raw materials of the manufacturer. Besides, different color rank codes (identical codes) correspond to different chromaticity coordinate values. When using these light-emitting diodes to form the LED light bar as the light emitting unit, the identical code can be obtained accordingly. Herein, the identical code is located on the LED light bar. For example, the identical code can be printed on the flexible circuit board of the LED light bar. Accordingly, the light emitted from the light emitting unit with the certain identical code can correspond to a set of chromaticity coordinate values in the CIE 1931 chromaticity coordinate. The chromaticity coordinate values of the display device can be obtained by multiplying the spectrum of the light-emitting diode and the spectrum of the color photoresist in the display panel. If the spectrum of the color photoresist in the display panel is fixed, the change of the spectrum of the light-emitting diode can determine the chromaticity change of the display device. As a result, the equation of the relationship of the chromaticity of the LED and the chromaticity coordinate values of the display device can be found.

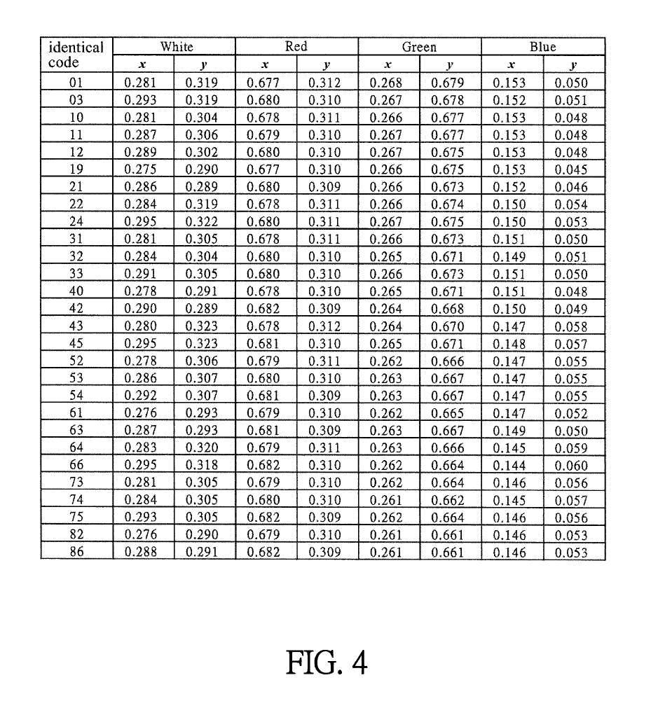

FIG. 4 is a schematic diagram showing a table containing the WRGB chromaticity coordinate values in the CIE 1931 chromaticity coordinate corresponding to different identical codes. Accordingly, when the identical code of the light emitting unit of the backlight module 13 is obtained, it is possible to retrieve a set of chromaticity coordinate values from a lookup table according to the identical code. Then, the system circuit board 12 can adjust the color presentation of the display panel 11 according to the set of chromaticity coordinate values, thereby providing the display panel 11 with a better color expression.

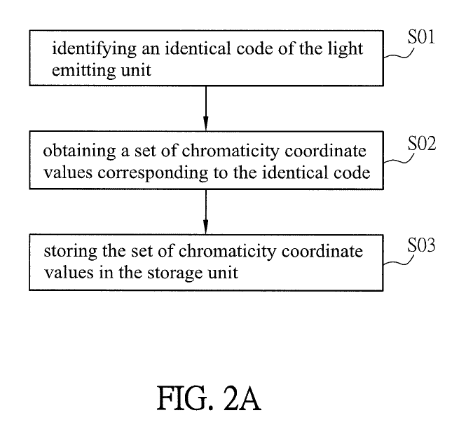

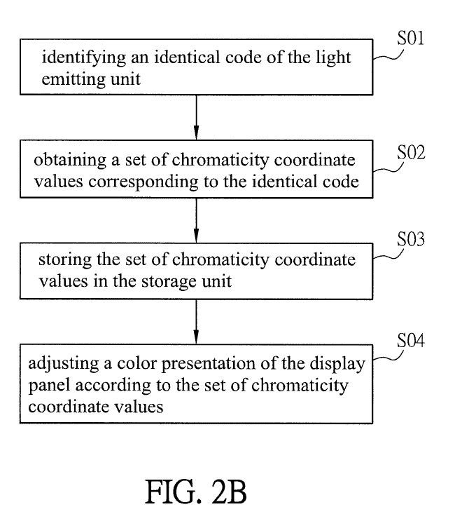

A color adjusting method of the display device 1 according to an embodiment of the disclosure will be illustrated with reference to FIG. 2A in view of FIG. 1C. FIG. 2A is a flow chart of a color adjusting method of a display device according to an embodiment of the disclosure.

The technical features of the display device 1 can refer to the above embodiment, so the detailed description thereof will be omitted. As shown in FIG. 2A, the color adjusting method of the display device 1 includes the steps S01 to S03.

The first step S01 is to identify the identical code of the light emitting unit of the light emitting module 13. For example, the identical code of the light emitting unit can be a color rank code, a product number, a batch number, or a manufacturing number of the light-emitting diode of the light emitting unit. In this embodiment, the identical code is a color rank code of the light-emitting diode of the light emitting unit.

Next, the step S02 is to obtain a set of chromaticity coordinate values corresponding to the identical code. The set of chromaticity coordinate values indicates a point in the CIE 1931 chromaticity coordinate corresponding to the display panel. In one embodiment, the step S02 is to obtain the set of chromaticity coordinate values from a lookup table (as shown in FIG. 4) according to the identical code. Of course, in other embodiments, the set of chromaticity coordinate values corresponding to the identical code can be obtained by other approaches, and this disclosure is not limited.

Afterwards, the step S03 is to store the set of chromaticity coordinate values in the storage unit 1231 of the system circuit board 12. In this embodiment, the storage unit 1231 is an internal memory of the timing control circuit 123. In addition, the set of chromaticity coordinate values (e.g. the WRGB chromaticity coordinate values in the CIE 1931 chromaticity coordinate) is stored in the storage unit 1231 to be a part of the EDID data.

FIG. 2B is a flow chart of another color adjusting method of a display device according to the embodiment of the disclosure. As shown in FIG. 2B, the color adjusting method further includes a step S04, which is to adjust a color presentation of the display panel 11 according to the set of chromaticity coordinate values. In general, the graphic processor (e.g. CPU or GPU) of the system circuit board of the display device can read out the chromaticity coordinate stored in the storage unit 1231 and create an array conversion equation for converting the chromaticity coordinate stored in the storage unit 1231 to a preset conversion chromaticity coordinate. This equation is built in the graphic processor. Accordingly, the inputted RGB signals can be converted by the conversion equation so as to obtain the desired RGB chromaticity signal.

The other technical features of the color adjusting method of the display device can be referred to the above embodiment, so the detailed description thereof will omitted.

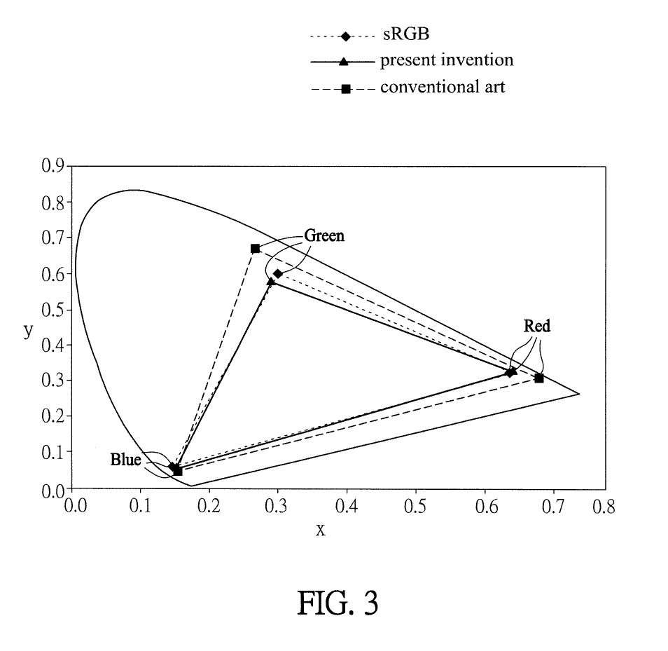

FIG. 3 is a schematic diagram showing a CIE 1931 chromaticity coordinate corresponding to the light emitted from the display device.

As shown in FIG. 3, the conventional art is to setup the display panel to a preset chromaticity coordinate values (the preset data are stored in the EDID memory), and the chromaticity range of the conventional art has a large gap with the sRGB standard chromaticity coordinate values. This large gap means the color presentation of the conventional art may easily have distortion. However, the gap between the chromaticity coordinate values obtained by the method of the disclosure and the sRGB standard chromaticity coordinate values is relatively smaller, which means the disclosure can provide a better color presentation.

To be noted, in one embodiment, the conventional art is to write the preset chromaticity coordinate values (e.g. 8 (x, y) coordinate values) into the EDID memory of the display device, and the color display of the display panel of the conventional art has an error of 30/1000 with comparing to the real measured chromaticity expression. However, the color display of the display panel of the disclosure has only an error of 10/1000 with comparing to the real measured chromaticity expression. Although the error of 10/1000 is not as good as the approach of performing the chromaticity measurement for all display panels (an error of 3/1000), the present disclosure can achieve an acceptable color presentation without the high-cost and long-term chromaticity measurement procedure. As a result, the present disclosure has the advantage of lower cost so as to improve the product competitiveness.

In summary, the present disclosure is to identify the identical code of the light emitting unit, to obtain a set of chromaticity coordinate values corresponding to the identical code, and then to store the set of chromaticity coordinate values in the storage unit of the system circuit board. Accordingly, the system circuit board can adjust the color presentation of the display panel according to the set of chromaticity coordinate values. Compared with the conventional art, which is to write the preset chromaticity coordinate values into the EDID memory of the display device, the present disclosure can achieve better color presentation. In addition, compared with the conventional art of measuring the real chromaticity of all display panels, the present disclosure has the obvious advantage of lower cost, which can improve the product competitiveness.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display device, comprising:
a display panel;
a system circuit board electrically connected to the display panel and comprising a storage unit, wherein the storage unit stores a set of corresponding chromaticity coordinate values of the display panel; and
a backlight module disposed corresponding to the display panel for emitting a light to pass through the display panel, wherein the backlight module has a light emitting unit, the light emitting unit has an identical code, and the identical code corresponds to the set of chromaticity coordinate values.

2. The display device according to claim 1, wherein the system circuit board further comprises a timing control circuit, and the storage unit is an internal memory of the timing control circuit.

3. The display device according to claim 1, wherein the system circuit board further comprises a central processing unit, and the storage unit is an internal memory of the central processing unit.

4. The display device according to claim 1, wherein the light emitting unit comprises at least a light-emitting diode, and the identical code is a color rank code, a product number, a batch number, or a manufacturing number.

5. The display device according to claim 1, wherein the system circuit board adjusts a color presentation of the display panel according to the set of chromaticity coordinate values.

6. The display device according to claim 1, wherein the storage unit stores extended display identification data (EDID) of the display device.

7. The display device according to claim 1, wherein the light emitting unit comprises a LED light bar, the LED light bar comprises a flexible circuit board, and the identical code is located on the flexible circuit board.

8. The display device according to claim 1, wherein the set of chromaticity coordinate values is obtained from a lookup table according to the identical code.

9. The display device according to claim 1, wherein the set of chromaticity coordinate values indicates a point in CIE 1931 chromaticity coordinate corresponding to the display panel.

10. A color adjusting method of a display device, wherein the display device comprises a display panel, a system circuit board and a backlight module, the system circuit board is electrically connected to the display panel and comprises a storage unit, the backlight module is disposed corresponding to the display panel for emitting a light to pass through the display panel, the backlight module has a light emitting unit, and the light emitting unit has an identical code, the color adjusting method comprising steps of:
identifying the identical code of the light emitting unit;
obtaining a set of chromaticity coordinate values corresponding to the identical code; and
storing the set of chromaticity coordinate values in the storage unit.

11. The color adjusting method according to claim 10, wherein the set of chromaticity coordinate values indicates a point in a chromaticity coordinate corresponding to the display panel.

12. The color adjusting method according to claim 10, wherein the system circuit board further comprises a timing control circuit, and the storage unit is an internal memory of the timing control circuit.

13. The color adjusting method according to claim 10, wherein the system circuit board further comprises a central processing unit, and the storage unit is an internal memory of the central processing unit.

14. The color adjusting method according to claim 10, wherein the step of obtaining the set of chromaticity coordinate values corresponding to the identical code is to obtain the set of chromaticity coordinate values from a lookup table according to the identical code.

15. The color adjusting method according to claim 10, further comprising a step of:
adjusting a color presentation of the display panel according to the set of chromaticity coordinate values.

16. The color adjusting method according to claim 10, wherein the storage unit stores extended display identification data (EDID) of the display device.

17. The color adjusting method according to claim 10, wherein the light emitting unit comprises a LED light bar, the LED light bar comprises a flexible circuit board, and the identical code is located on the flexible circuit board.

18. The color adjusting method according to claim 10, wherein the light emitting unit comprises at least a light-emitting diode, and the identical code is a color rank code, a product number, a batch number, or a manufacturing number.
